(19) United States
(12) Patent Application Publication
(10) Pub. No.: US 2004/0128430 A1
(43) Pub. Date: Jul. 1, 2004

(54) Accessing data from non-volatile memories

(76) Inventor: John C. Rudelic, Folsom, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/331,710

(22) Filed: Dec. 30, 2002

(51) Int. Cl. G06F 12/00

(52) U.S. Cl. 711/102; 711/103

(57) ABSTRACT

A hardware comparator may be utilized to locate data in non-volatile memories such as flash memories. By using a hardware, instead of a software, approach, the access speed may be improved and the load on the unit that executes the software may be reduced.

### BACKGROUND

This invention relates generally to non-volatile memories that store data without needing to be dynamically refreshed.

A flash memory is one type of non-volatile memory. In order to access data within a flash memory, a media manager is utilized. The media manager controls the accessing of the non-volatile array. In particular, it copies information out of blocks of stored data, erases blocks, writes information, and updates information to the same or another block. In accessing information, the media manager translates logical information to access data in the memory array into physical positions of blocks in the array. The media manager generally causes one or more mapping structures to be stored somewhere in the array.

The data within the array may be stored in the form of objects. An object is a granularity of storage. A granularity is the minimum amount of space that can be allocated. A block stores one or more objects plus object headers and allows data to be stored logically contiguously, rather than physically contiguously.

Generally, flash and other non-volatile file systems fragment data before storing the data in the memory. Fragmenting is a process that breaks data into smaller, more manageable items that are stored to the memory array. Due to breaking the data into relatively smaller units, flash file systems typically spend a significant amount of time searching for specific fragments in the memory.

Currently media management software is executed to search for the desired fragment. This code is typically executed repeatedly to find any specific object. The same code is then executed many more times to string individual objects together. The repetitive nature of the fragment search is a non-productive process. Not only is it processor intensive, diverting the processor unnecessarily to the search process, but it also slows the accessing of data.

Thus, there is a need for better ways to access data from non-volatile memories such as flash memories.

### BRIEF DESCRIPTION OF THE DRAWINGS

FIG. 1 is a schematic depiction of one embodiment of the present invention;

FIG. 2 is a schematic depiction of an implementation, in accordance with one embodiment of the present invention, of the features shown in FIG. 1; and

FIG. 3 is a system depiction of one embodiment of the present invention.

### DETAILED DESCRIPTION

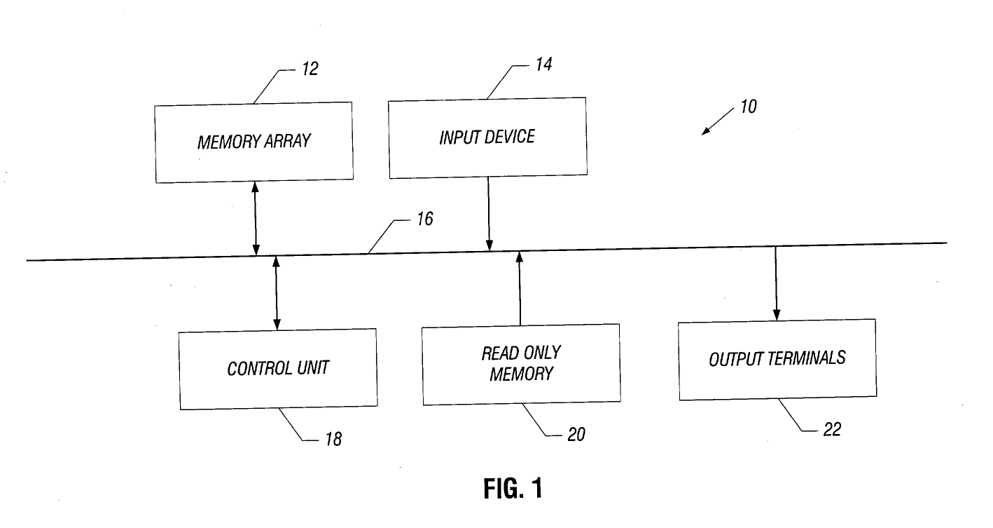

Referring to FIG. 1, a non-volatile memory 10, such as a flash memory, may include a memory array 12 coupled by an interface 16, such as a bus, to a control unit 18, a read-only memory 20, an input device 14, and output terminals 22. A media manager includes software that is implemented through the control unit 18 and read-only memory 20. The media manager may be stored in the read-only memory 20 so that it is always available and cannot be erased.

However, instead of relying on the media manager to locate objects of data in the array 12, a hardware implementation may be used. This hardware may be resident within the control unit 18 in one embodiment of the present invention.

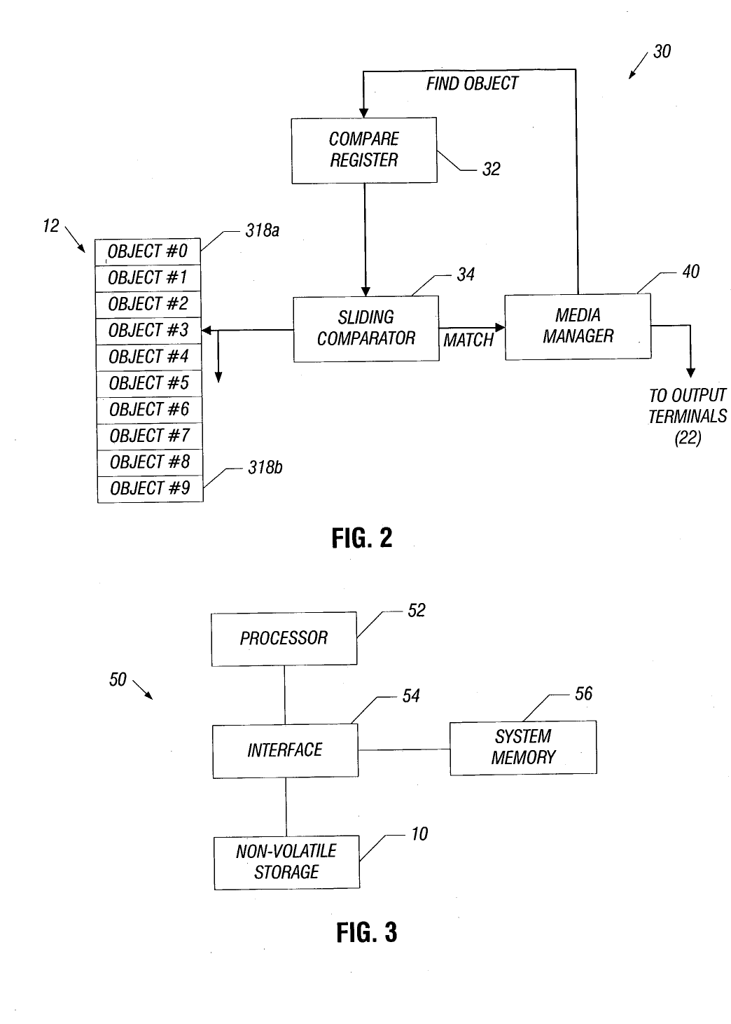

Referring to FIG. 2, the array. 12 is schematically depicted as a large concatenated list of objects 318, including an object #0 318a and an object #9 318b, although in practice many more objects would be resident within typical memory arrays 12. A hardware system 30, including a sliding comparator 34, sequentially accesses the objects 318 in the array 12 to determine whether any of the objects are objects that have been requested, for example through the media manager 40.

Thus, the media manager 40 may receive a request through an input device 14 for particular data stored in the memory array 12. Instead of executing software to find that object, the media manager 40 simply sends the pertinent identifying information to a compare register 32. The identifying information for the object(s) sought is stored in the compare register 32. A sliding comparator 34 sequentially checks the header information associated with each object 318 to determine whether that object's identifier corresponds to the identifier of the target object in the compare register 32. The identifying information may include as examples, an object identifier, an object address, or object data.

When a match between the identification of an object in the register 32 and an object 318 is found, the comparator 34 notifies the media manager 40 and provides the location information. The media manager 40 may enable access to the requested objects through the output terminals 22 in a conventional fashion.

In some embodiments, the system 30 may simply start at a first block and search the objects 318 to the end of the block for a match. Each individual object 318 may be compared with the value in the compare register 32. If the match is unsuccessful, the sliding comparator 34 slides to the next modulo address to test for a comparison. When a match is found, the location of the matching object is passed back to the media manager 40.

In some embodiments, the hardware system 30 may take less time to find objects than a software comparison algorithm. Thus, the access time may be improved in some embodiments and the control unit may be freed to execute other tasks in some cases. In some cases, some objects may be found in some blocks using the software technique and other objects may be found using the hardware technique described herein.

Examples of applications for data storage include parameter or data storage and/or file management in cellular phones and storage files in personal digital assistants.

Referring to FIG. 3, a system 50 may include a processor 52, coupled through an interface 54, to a system memory 56 and a non-volatile storage 10. The non-volatile storage 10 may use the hardware system 30. The processor 52 may be a conventional, general purpose processor or it may be a digital signal processor, to mention two examples.

The system 50 may be any of a variety of devices, including wired and wireless devices and mobile and non-mobile devices. Examples of mobile devices that are well suited to using the concepts described herein include personal digital assistants and cellular telephones.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving an identification of an object in a non-volatile memory; and
comparing said identification in a hardware comparator to each of a plurality of object identifiers for objects in said memory to locate the object in said memory.

2. The method of claim 1 including storing said identification in a register accessible by said hardware comparator.

3. The method of claim 1 including successively accessing successive objects in said memory.

4. The method of claim 3 including accessing an identifier associated with an object in said memory and comparing said identifier to said identification of an object to determine if there is a match.

5. The method of claim 4 including reporting said match to a media manager.

6. A non-volatile memory comprising:
a memory array; and
a hardware comparator to receive an identification of an object in said array and to check objects in said array to see if an identifier associated with an object in said array matches said identification.

7. The memory of claim 6 wherein said memory array is a flash memory array.

8. The memory of claim 6 including a register to store said identification.

9. The memory of claim 6 wherein said comparator successively accesses successive objects in said array.

10. The memory of claim 9 wherein said comparator accesses an identifier associated with an object in said array and compares said identifier to said identification of an object to determine if there is a match.

11. The memory of claim 6 including a media manager.

12. The memory of claim 11 wherein said comparator is coupled to said media manager.

13. A system comprising:
a digital signal processor; and
a non-volatile memory coupled to said digital signal processor, said memory including a memory array and a hardware comparator to receive an identification of an object in said array and to check objects in said array to see if an identifier associated with an object in said array matches said identification.

14. The system of claim 13 wherein said memory is a flash memory.

15. The system of claim 13 including a read-only memory storing a media manager.

16. The system of claim 15 wherein if there is a match between said identification and said identifier, said comparator reports said match to said media manager.

17. The system of claim 13 wherein said memory includes a register accessible by said comparator.

18. The system of claim 13 wherein said comparator automatically successively accesses successive objects in said array.

19. The system of claim 17 wherein said comparator determines if there is a match between an identifier associated with an object in said array and identification of an object received by said comparator.

20. The system of claim 13 wherein said comparator successively checks the identifiers of a plurality of objects in said array.
